(19) United States
(12) Patent Application Publication
(10) Pub. No.: US 2024/0394008 A1
(43) Pub. Date: Nov. 28, 2024

(54) Technological Advancement to Memory Books

(71) Applicant: Robyn Okonsky, Red Deer (CA)

(72) Inventor: Robyn Okonsky, Red Deer (CA)

(21) Appl. No.: 18/202,893

(22) Filed: May 27, 2023

(51) Int. Cl. G06F 3/147; B42F 5/00; G06F 3/16

(52) U.S. Cl. CPC G06F 3/147; B42F 5/00; G06F 3/16; B42P 2241/16

(57) ABSTRACT

In a world with technology readily available to capture photos and videos, people have large collections of their favorite memories in digital form. The invention provides a screen to play videos and listen to audio, integrated into a book, for the purpose of memory preservation. The current invention discusses a novel form of memory book with an integrated video screen built on non-bendable material wherein the technological part is removable and replaceable either by removing a page in case of a binding cover wherein the binding system allows for the book to be opened up and reassembled or an alternate design of removing the screen when it attaches with magnets, sliding in and out of place, or is placed within a friction fit case. These memory books provide the option to record, edit and upload digital media files, to view and listen to content within the structure of a book.

### BACKGROUND

### Field of the Invention

This invention generally relates to memory and photo books, both professionally printed and those assembled by the user with paper craft scrapbooking. The invention provides further convenience and functionality to an existing product, by integrating motion video and audio by way of a video screen into books. There is an accessible USB port where the user can load their own content onto the device, or alternatively an app can give the means for users to load content onto the device from a mobile device.

### Description of the Related Art

There are meaningful events in a person's life for which large numbers of the person's friends and family gather together in celebration. Weddings, bridal showers, graduations, baby showers, baptisms, first communions, confirmations, birthdays, retirements, and bar mitzvah's are among these events. Due to the nature of the events, and to their infrequency, such events generally evoke strong emotions in the celebrated person. The celebrated person often desires to capture the memories of such an event to preserve them for life-long enjoyment. Books are used to capture what life is like in periods of time, and can act as a way to preserve information, data and knowledge. In some instances, one scrapbook may be used to memorialize a variety of such events, where each page of the scrapbook is dedicated to a single event. In other instances, a single scrapbook may be devoted to an event or category. For example, a scrapbook may be devoted to one or more of a person's children with individual pages or groups of consecutive pages representing specific events such as birthdays, graduation, etc. Additional examples could be a scrapbook devoted to family vacations, family recipes, family history, tributes, sports and activities, etc.

The prior art discloses many examples of patents for books that are intended for people to write into, but none providing the combination of features disclosed and claimed herein.

U.S. Pat. No. 1,161,580 issued to I. R. Allen on Nov. 23, 1915 discloses a scrapbook. This patent is for a scrapbook for the storage of items such as pictures and mementos. While this product provides a storage place for the items, the items are placed into the scrapbook in a random fashion and the scrapbook is intended to store items. The patent does not provide a specific place for writing, nor does it provide for daily writings or offer encouragement or suggestions for the writing or memories.

U.S. Pat. No. 4,793,634 issued to Alloggiamento on Dec. 27, 1988 discloses an original perpetual diary calendar. This patent provides an erasable section(s) that allows sections of the diary to be erased and different information to be placed onto the pages. While this product provides a place for writings, the writings are intended to be erased and not stored for future sharing. The patent does not allow for the storage of items in the diary. The patent does provide for daily writing or offers encouragement or suggestions for the writing or memories.

U.S. Pat. No. 5,374,083 issued to Slocomb on Dec. 20, 1994 discloses a variable period diary. This patent provides flexibility for an author to use as much or as little of the diary as needed to store writings. The patent does not allow for storage of items in the diary. The patent does provide for daily writings or offer encouragement or suggestions for the writing or memories.

U.S. Pat. No. 6,347,811 issued to Bianco Feb. 19, 2002 discloses a structure of a diary of high practicality of use. This patent provides for a structured writing. This patent forces a person to write in a structured manner and does not allow free writing for maximum creativity. The patent does not allow for storage of items in the diary. The patent does provide for daily writings or offer encouragement or suggestions for the writing or memories.

U.S. Design Pat. No. D278,352 issued to Wenstrom et al. Apr. 9, 1985 discloses a diary. This patent is basically a design of a diary that includes a lockable function to prevent others from reading the diary. While this patent allows for writings it contradicts the purpose of the proposed application that is intended to share the writings and memories. The patent does not allow for storage of items in the diary. The patent does provide for daily writings or offer encouragement or suggestions for the writing or memories.

US Pat. No. 2,008,0238079A1 discusses memory diary book. The memory book or diary intended for recording pleasant memories for sharing in the future. This book may include dedications, suggestions, encouragement, guidance, advice, and storage pouches to promote and support relationships. The book may also include clinical or problem solving tools or techniques to improve a relationship. The book is for immortalizing pleasant memories, sentiments, events, gifts exchanged or memories shared. The book can be shared by partners, siblings, parents, pet owners, and are ideally suited to document the beginning of relationships, marriages, pet owners or parenthood. The book can be shared in the future to relive the memories captured in the book.

A U.S. Pat. No. 2,010,0164836A1 on the digital photo albums, digital book, digital reader in one embodiment, a digital viewing unit for viewing digital media and a storage location for housing digital media viewable on the digital viewing unit.

A U.S. Pat. No. 4,159,417A relates to electronic book wherein the contents of a book, magazine or the like are digitally encoded onto a memory, and the memory is removably insertable into a portable book-like apparatus whereby the encoded information can be displayed on a screen of the apparatus.

A U.S. Pat. No. 5,761,485A relates to personal electronic book system. The Personal Electronic Book System invention replaces a standard handheld book with an electronic equivalent. The invention is sized and configured to be book size and to open like a book for use. When opened, the user sees two facing page-like touch-sensitive, display screens with black print on white background. Icons represent the electronically stored material, “artwork, audio clips, books, E-mail, faxes, games, magazines, movies, musical compositions, newspapers, photographs, software, video clips, etc.”, which are selected by touching the icon. When a book, magazine, newspaper, or the like is selected, its table of contents is displayed and the user can then read page by page or go directly to a particular page by touching the selection listed in the table of contents. Closing the Personal Electronic Book automatically shuts down the device. Touching a page number before closing the Personal Electronic Book inserts a bookmark so that when the Personal Electronic Book is re-opened, the user is returned to the same page. New printed or multimedia material can be downloaded from a remote server, that is, “a bookstore,” and old material, books read, etc., can be deleted to make room for the new material.

There are multiple solutions that have been presented in the prior art. However, these solutions are limited and restricted to their conventional systems. The current invention is an improved product that better enables a person to reflect their individual experiences in a memory book. When integrating into scrapbook-style albums the assembly includes a plastic side with holes to go into a post-bound book, wherein the board houses the video screen and is covered with paper. The assembly further presents a video screen in a book form allowing users to watch videos with related audio to provide a better experience. It also allows to integrate a video screen into a book for video and audio options allowing the user to have a better and more realistic experience. The assembly provides an easy-to-use interface that works well even if the technological function stops working. Thus, providing the same outlook and output over a longer period of time. The proposed book structure aims to retain the memories in book form without depending on the technological structure and removing the audio/video feature will not affect the outlook and expected output from the book.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The primary objective of this invention is to provide an improved product that better enables a person to reflect on their individual experiences in a book, by being able to hear audio and view full motion video content on a screen.

Another objective of the invention is to provide a card assembly that presents a portable, electronic viewing device to play created video content of special events and photo slide shows that highlight life events and memories.

Another objective of the invention is to provide an innovative method for retaining memories by recording, saving, and streaming the audio and videos which can be easily accessed and listened to or viewed later.

Another objective of the invention is to provide an assembly with a portable, electronic viewer which reads stored and encoded information and which displays the information in readable form on a thin electrical display screen.

It is a further objective of the invention to provide a portable, electronic viewer capable of receiving and displaying the contents such as video, within a book that has other printed or assembled pages.

Another objective of the invention is to provide a durable hardcover that protects the inner pages from damage, sustains heavy use, and lasts for years.

Another objective of the invention is to provide a book assembly that is portable, that includes an electronic viewer and includes a button to turn the assembly on/off.

It is moreover the objective of the system to provide multiple options including but not limited to the option to record audio within the device, save, and play it back. It also provides the option to record, edit and save the recordings.

The assembly further includes a mechanism to turn on/off the device wherein it also includes navigation to play and go through content, adjust volume and a rechargeable battery for the device for long-term use.

It is also the objective of the invention to be replaced, if the tech fails and doesn't last the life of the book. Thus the assembly provides the expected output over a longer period of time.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is the folded card view of the assembly as per the preferred embodiments of the invention.

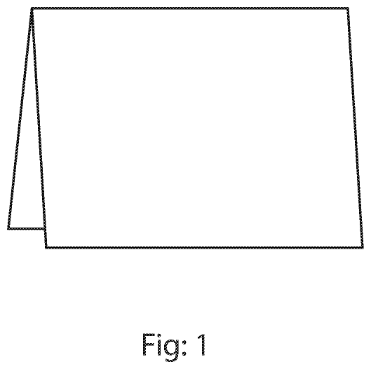

FIG. 2 shows the video screen built within the paper of folded greeting card, which can be on the cover or inside as per the preferred embodiments of the invention.

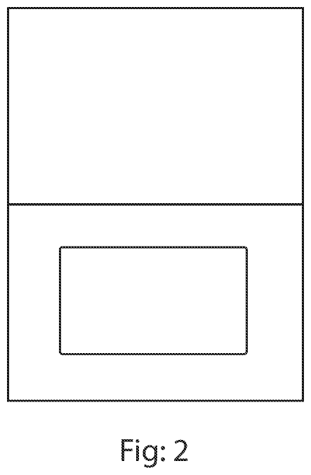

FIG. 3 shows the folded card portrait orientation as per the preferred embodiments of the invention.

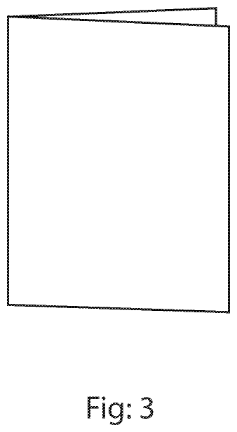

FIG. 4 shows the video screen built within paper card portrait orientation assembly as per the preferred embodiments of the invention.

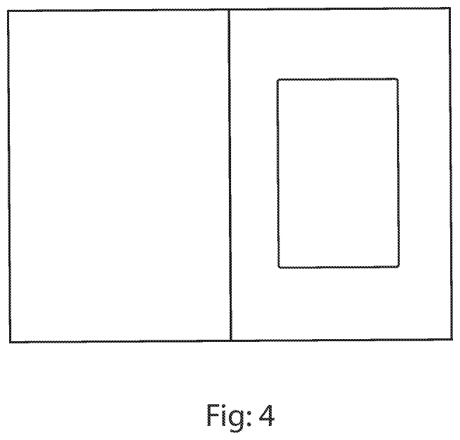

FIG. 5 shows the integrated, removable audio video tech device within the bottom of a printed bound book as per the preferred embodiments of the invention.

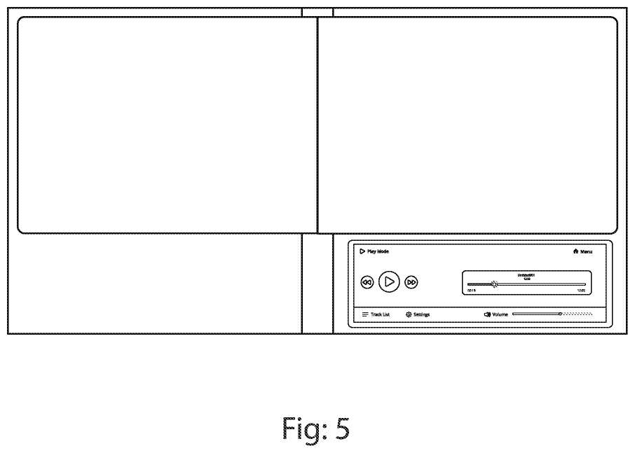

FIG. 6 shows the magnetic bar that the AV tech device connects to with the back and sides of the device being iron as per the preferred embodiments of the invention.

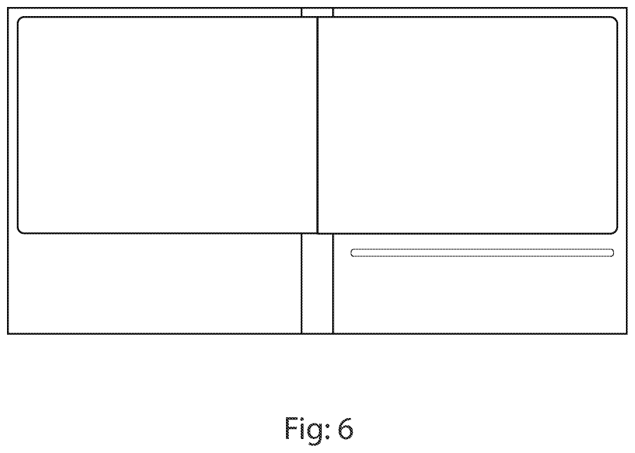

FIG. 7 shows the double magnetic bar that the AV tech device connects to as the back and sides of the device that is made of the iron as per the preferred embodiments of the invention.

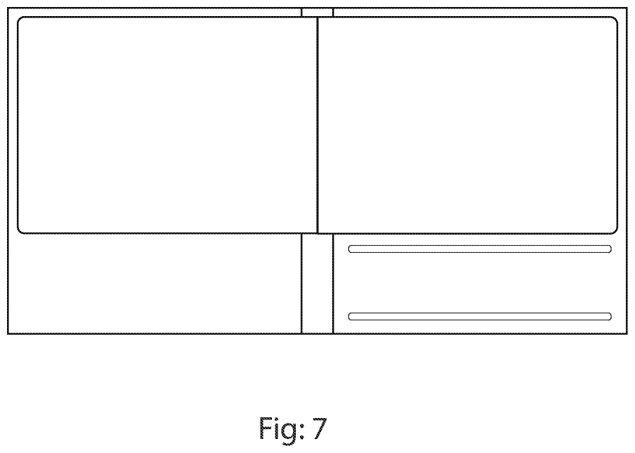

FIG. 8 shows the casing in the book that the AV tech device connects into as per the preferred embodiments of the invention.

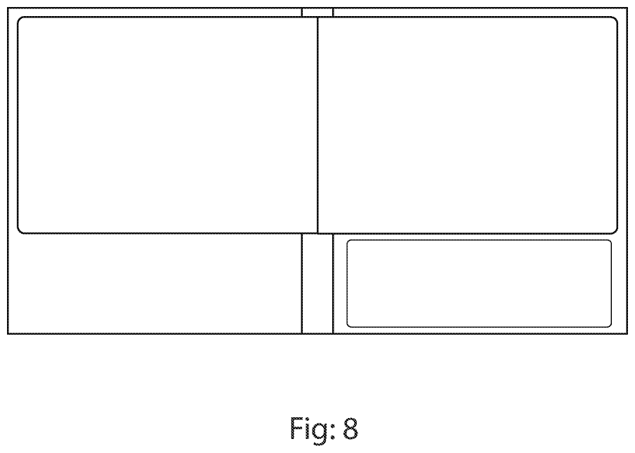

FIG. 9 shows a page with a built-in removeable video screen in paper signatures being bound into the book as per the preferred embodiments of the invention.

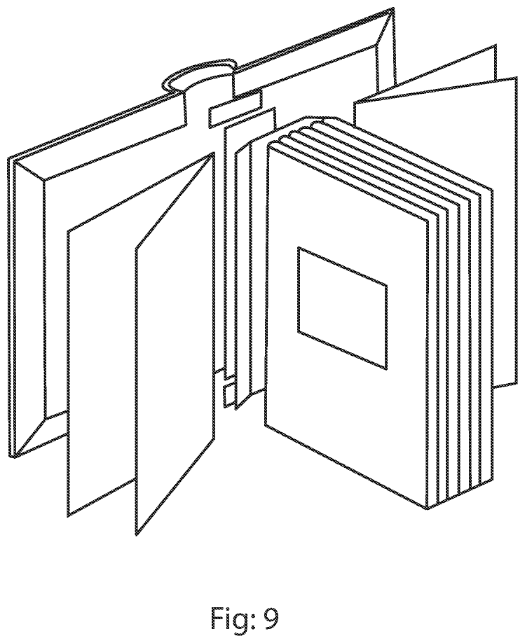

FIG. 10 shows a removeable video screen built within the front cover of the book as per the preferred embodiments of the invention.

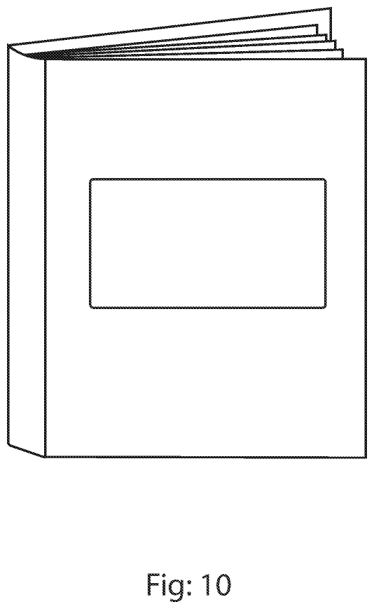

FIG. 11 shows a removeable video screen built within the page in the bound book as per the preferred embodiments of the invention.

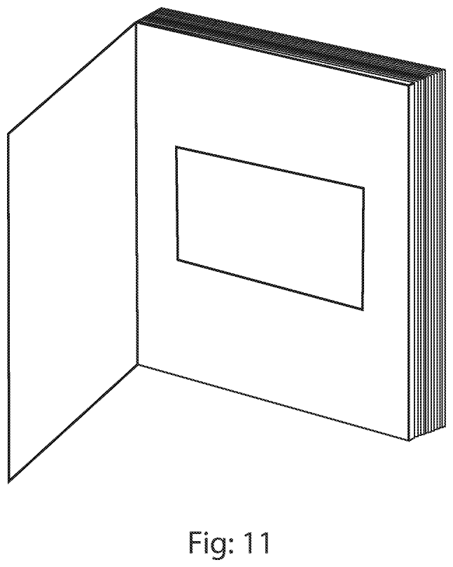

FIG. 12 shows a removeable video screen built within the inside front cover in a printed and bound book as per the preferred embodiments of the invention.

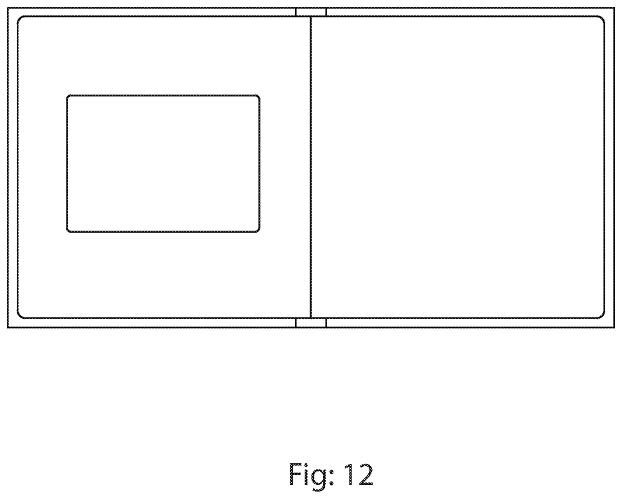

FIG. 13 shows a removeable video screen built within the inside front cover as per the preferred embodiments of the invention, where the device can be removed and replaced, if required.

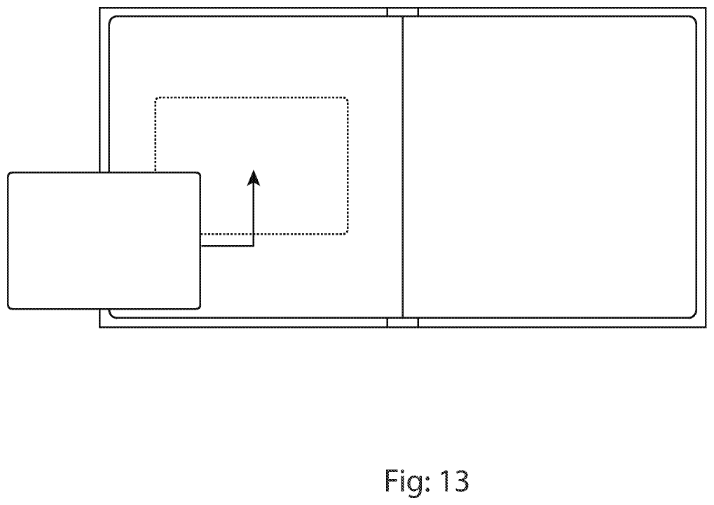

FIG. 14 shows a single page built with a video screen with a flexible plastic side and 3 holes to go into a post-bound, ring binder, or strap bound album as per the preferred embodiments of the invention.

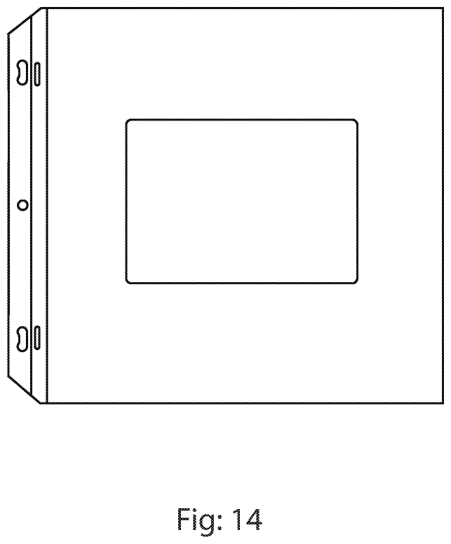

FIG. 15 shows a video page within a post bound book as per the preferred embodiments of the invention.

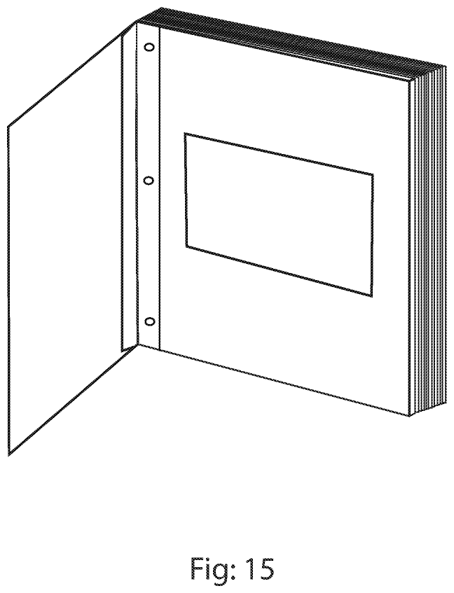

FIG. 16 shows a video page within a 3-ring binder style book as per the preferred embodiments of the invention.

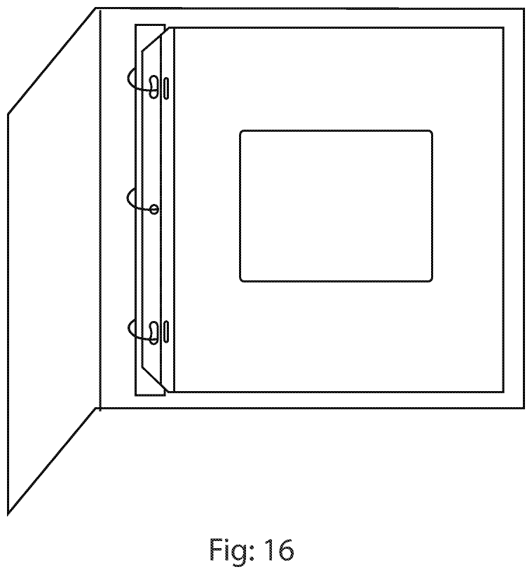

FIG. 17 shows a video page within a strap-bound album as per the preferred embodiments of the invention.

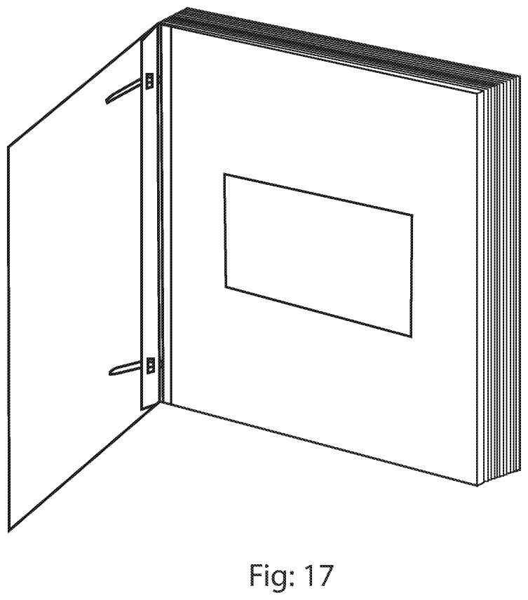

FIG. 18 shows a removeable video screen going into a slide-in rail system built within the back cover of a bound book as per the preferred embodiments of the invention.

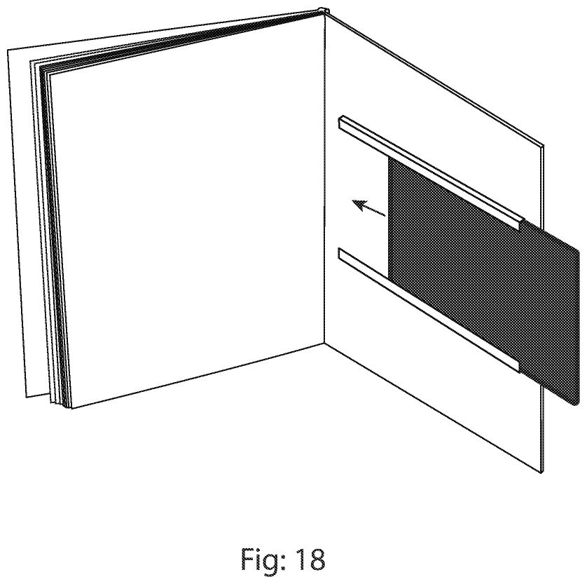

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The present invention relates to a dynamic tactile page developed from physical material and has an in-built video screen allowing people to turn pages, view photographs, read text, listen to recordings, and watch videos related to a particular event.

In accordance with the present invention, a book assembly with various technological advancements is disclosed. The assembly is in form of a book-shaped housing having the look and feel of a real, paper book. The book-shaped housing has a first housing member pivotably connected to a second housing member to facilitate opening and closing in a book-like manner. The first housing member is partially formed by a book-like, front-cover member. In a similar manner, the second housing member is partially formed by a book-like, back cover member. The front cover member and the back cover member are pivotably connected by a spine member.

To better provide the look and feel of a real book, the front cover member and the back cover member have an exterior made of the material used in real book covers. Examples of such a material include but are not limited to, leather, simulated leather, vinyl, and a woven fabric such as cotton or linen. The exterior can be permanently affixed to the front cover member and the removable back cover member.

In addition to the front cover member, the first housing member is partially defined by an enclosure. Similarly, the second housing member is partially defined by an enclosure in addition to the back cover member. When the assembly is in the closed position, the enclosure has an external appearance of edges of pages of a real, paper book

The assembly can be viewed conveniently in an open position. It is preferred that the first housing member and the second housing member be substantially symmetric so that the front cover member, the back cover member, and the spine member rest substantially flat on a flat surface in the open position. The book can be comfortably held and read in a manner consistent with a paper book. The book assembly provides an easy way to add videos into books that contain tactile pages with physical material that can be seen and touched to turn pages and view photographs, writing, and memories.

A touchscreen may be integrated in the book-shaped housing to be accessible when the book-shaped housing is opened in a book-like manner. The touchscreen includes a touch-sensitive panel over a display device. Behind the display device can be a backlighting element. The assembly further includes a video display panel and associated audio panel with the function to accept digital media files such as photos, videos and audio files for playback through a user interface on the device. The video screen may be built within the paper of folded greeting card. The video screen can be built within a structure that can be removed and replaced wherein the device can be attached with connection to strong magnets built within a book, to the iron on the back and sides of the device, and removed by pulling the device from the magnetic connection; alternatively the device can be attached with connection to strong magnets built onto the back of the device and to an iron plate built into the book; alternatively connecting into a friction fit case that is permanently affixed within a book, alternatively sliding the device into and out of a rail mechanism in the book which can be on the cover or inside of a book; or in the instance or a scrapbook bound album with removable pages as per the binding mechanism, the device is built within a page that has a plastic flexible side with 3 holes that fits into the binding mechanism. The video screen gives the ability to play digital multi-media files, full motion video, and audio.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. A memory book comprising:
a) a memory book page with physical material that can be seen and touched to turn pages and view photographs, writing, and memories.
2. The memory book of claim 1, wherein an integrated video screen gives the ability to play digital multi-media files, full motion video, and audio.
3. The memory book of claim 1, wherein the integrated video screen can be inserted and removed easily.
4. The memory book of claim 1, wherein the integrated video screen provides a visual display and audio output.
5. The memory book of claim 1, wherein the integrated video screen can be removed and the expected outcome can still be achieved in tactile form.
6. The memory book of claim 1, wherein the integrated video screen within books is inbuilt in various ways to ensure that if the tech fails, the component is removable and replaceable by either removing a page if the binding system allows for the book to be opened up and reassembled or an alternate design of removing the screen when it attaches with magnets, sliding in and out of place, or is placed within a friction fit case.
7. The memory book of claim 1, wherein for scrapbook style albums, the binding can be opened up by way of post binding, 3 ring binders, or strap binding to insert, remove, or re-order pages.
8. The memory book of claim 1, wherein for scrapbook style album it can be a single rigid, non-bendable page, and that will support the device and its weight to protect the device.
9. The memory book of claim 1, wherein for scrapbook style, the holes on the side of the page in plastic that is flexible to fit within many different album configurations.
10. The memory book of claim 1, wherein for books that have fixed biding the device is removable and replaceable.
11. The memory book of claim 1, wherein for fixed books the removal of the device is secured through magnets, the friction fit into a case in the book that the device fits into, slide in pocket/casing and slide in rails.
12. The memory book of claim 1, wherein a method of recording, saving, and streaming of audio and videos is presented.
13. The memory book of claim 1, wherein once audio or video is uploaded is stored in the backend database.
14. The memory book of claim 1, wherein the data can be retrieved and can be displayed and listen to the story associated with any event.

2. An advanced assembly related to memory books wherein:
15. The memory book as per claim 2, wherein the tech panel allows the user to save the textual, photos, audio, and video input in the memory storage backend.
16. The memory book as per claim 2, wherein the tech panel allows the user to access the data conveniently as desired in textual, photo, audio, and video formats.
17. The memory book as per claim 2, wherein the tech panel allows the user to view memories on the screen that is integrated into the memory book, allowing the user to watch photos, related text, audio, and videos.
18. The memory book as per claim 2, wherein the tech panel allows the user to record and edit media recordings.

3. The memory book with screen assembly with various structures to support various settings wherein:
19. As per claim 3, the binding of scrapbook-style albums can be opened up by way of post-binding.
20. As per claim 3, the three-ring binders, or strap binding allow inserting, removing or re-order of pages in a convenient manner.
21. As per claim 3, the assembly can include a single page that is rigid in material to not bend, and that will support the device and its weight to protect the device.
22. As per claim 3, the binding of scrapbook-style albums there are plastic holes on the side of the page that is flexible to fit within many different album configurations.
23 As per claim 3, the binding of the book style can be permanently affixed to the cover and inside pages.
24. As per claim 3, the integrated device is removable and replaceable with different options.
25. As per claim 3, the options to secure the device within may include magnets, friction fit into a case in the book that device fits into, slide-in pocket/casing, and slide-in rails.
26. As per claim 3, the device could be within the front cover, inside the front cover, back inside cover, or an inside page.
27. As per claim 3, when the device is within an inside page, the page itself is built to be stable on a rigid material so that it can handle the weight of the device to turn the page.
